(19) United States
(12) Patent Application Publication
(10) Pub. No.: US 2006/0142457 A1
(43) Pub. Date: Jun. 29, 2006

(54) Method for producing metallized paper or flexible substrate, coated flexible substrate having matt, semi-sheen or sheen metallized appearance, and, aqueous solution

(75) Inventor: Antonio Jose Morais Cunha, Rio de Janeiro (BR)

Correspondence Address: ARENT FOX PLLC, 1050 CONNECTICUT AVENUE, N.W., SUITE 400, WASHINGTON, DC, 20036, US

(73) Assignee: SCHWEITZER-MAUDUIT DO BRASIL S.A.

(21) Appl. No.: 11/287,248

(22) Filed: Nov. 28, 2005

(30) Foreign Application Priority Data
Nov. 29, 2004 (BR) PI0405338

(51) Int. Cl. C08K 3/08; B05D 1/02

(52) U.S. Cl. 524/439; 427/420; 427/421.1; 427/355; 428/323

(57) ABSTRACT

The present invention relates to a process for producing flexible substrates having metallized appearance for application in the field of packaging by way of a method for direct coating of the substrate that the user wishes to metallize, using coating application devices usually used by the paper industry, to apply an aqueous-base solution mainly comprised of polymers and fine particles of metal which, once dried, give the substrate sheen and metallic appearance. The product of this invention can be used as a substitute for paper metallized by vacuum or by lamination particularly in applications where the prime attribute of packaging is the visual aspect.

### FIELD OF THE INVENTION

The present invention relates to a new method for producing paper having a matt or semi-sheen metallic appearance for use in packaging which does not require an oxygen barrier, steam and/or humidity.

### BACKGROUND OF THE INVENTION

Since the beginning of the twentieth century, various methods have been developed with the objective of producing flexible substrates—paper, plastic or cloth among others—with a surface characterized by having a metallized appearance, and these materials can be applied to packaging, wherein such packaging may have a greater or lesser product quality depending on the production method employed. Below is a description of the main methods known to-date and their main characteristics.

The methods can be divided into two main groups: metallization methods by applying a metal laminate on the substrate surface (group I); and, methods by applying a flexible film containing metallic particles on the substrate surface (group II).

Group I

Lamination, used in group I methods, consists in the application of a fine metal laminate, normally aluminum, and the laminate adheres to the substrate by way of an adhesive film (aqueous or solvent base) previously applied to the substrate. This method is typically used for the metallization of card paper, and the metallic films typically have between 7 and 9 μm. Surface sheen and finishing do not depend solely on the substrate, but also on the sheen and finishing given to the laminate during the lamination process. Variations in color generating products with the appearance of gold, bronze or other metallic nuances are obtained by way of a subsequent process of printing with transparent colored varnish. This process is relatively expensive due to the cost of the metallic film.

Metallization by direct deposit on the substrate (vacuum metallization), used in group I methods, consists of depositing metallic particles on the surface of the paper in a high-vacuum environment, where the metal is vaporized and deposited on the substrate. This method is suitable for substrates that have no de-gasification of gasses or air present in their structure and that do not contain volatile substances. In the case of paper, the substrate should necessarily be a coated paper with a smooth and low porous surface, since the vacuum metallization on uncoated paper results in the product having a low-quality finishing. In order to achieve good metallization, it is often necessary to apply a “pore-filler” (varnish to seal the surface of the paper). Applied to paper or card, this method causes de-humidification of the substrate and consequently a permanent deformation of the substrate, so it is often necessary to re-humidify the substrate in order to avoid deterioration of the mechanical properties of the substrate.

Metallization by transfer, used in group I methods, is carried out in such a way that a transfer substrate (film made of polyethylene, polypropylene, cellulose acetate, etc.) is used where a metallized layer is deposited by the vacuum metallization method forming the transfer agent. The transfer agent is coated with a layer of varnish solvent base or a CJV varnish or electron ray or another type of resin which forms a high-adhesive film and is subsequently laminated on the substrate that the user wishes to laminate. After curing the resin/varnish, the next stage is to separate the transfer agent from the substrate, the metal layer remaining adhered on the substrate. The transfer substrate may be re-used while still permitting a good surface finishing quality. In the method which uses varnish solvent base, it is necessary to wait a minimum curing time of 24 hs, disrupting continuity of the conversion process and delaying inspection for the appraisal of quality obtained, which may end up causing losses on account of the delay in identifying process problems. When using materials with UV cure or electron ray, there is an immediate cure advantage with continuity of the process and quality inspection of the finished material. However, the UV varnishes are relatively expensive, so are the electron ray varnishes, investment in equipment is high, and so is the power consumption.

Group II

The metallic caseins (U.S. Pat. No. 2,459,408), used in the methods in group 11, are used in a aqueous solution comprising the casein ligant (protein extracted from milk), metallic pigment and others additives, which is applied to the substrate surface, in this case paper, card or cloth by application devices such as: airknife, applied roll, application blade or brush. The pigment content is low, not exceeding 20% of the solution. The use of casein as ligant fell into disuse as of 1935, being subsequently substituted for soy protein and then by synthetic ligants. The casein is extracted from milk after the removal of fat for the production of butter. In the past, it used to be a subproduct of skimmed milk processing. Currently, skimmed milk is considered an important product in the food industry, which has entailed a significant increase in the price of casein. Today, the use of casein in coated products is restricted to the addition as an additive in certain formulations of special paper.

The metallic coated paper (patent GB patent 546.333), used in the methods of group 11, is obtained by means of an aqueous solution comprising the alcohol polyvinylic ligant, metallic pigment and other additives, which is applied to the substrate surface, in this case paper, card or cloth by application devices such as: airknife, application roll, application blade or brush. The pigment is moistened by alcohols or naphthalene sulphonate or aliphatic alcohol sulphate. The quantity of pigment is significantly higher than the quantity of ligant, in the maximum ratio of 35 parts of ligant per 100 parts of pigment. Once the solution has been applied and dried, the substrate is calendared under high pressure, causing the material to achieve a high level of sheen and metallic appearance.

Metallic paint printing (U.S. Pat. No. 4,233,195), used in group II methods, is where a non-aqueous base solution comprising a varnish, metallic pigment and other additives is applied to the surface of the substrate, in this case paper or card by way of rotogravure printing devices. The pigment is moistened by alcohols and represents a maximum of 40% of the solution. The substrate with the solution already applied, but still moist, is compressed by a device which guides the metallic particles present in the solution, generating a surface with a high-sheen, metallic appearance. The quantity of coating applied varies between 0.5 and 10 g/m².

### THE PRESENT INVENTION

The present invention falls under Group II methods, that is, it is a method for producing a metallized paper or flexible substrate by applying directly on a substrate a solution containing polymers having the function of ligants and metallic pigments. The finished product may be used for packaging, with the objective of rendering a noble appearance to the product it contains, and may also, on account of the polymers used, provide protection against external factors which may compromise the integrity of the packaged material.

The present invention differs from the so-called metallic caseins by using acrylic polymers, styrene/acrylic or styrene/butadiene, resulting in lower production cost.

It differs from the so-called metallic coated papers by using acrylic polymers, styrene/butadiene or styrene/acrylic besides using low quantities of metallic pigments, not exceeding 35 parts of metallic pigment per 100 parts of ligants in the film formed on the paper, resulting in lower production costs.

The present invention differs from the co-called metallic printing by using a method in an aqueous medium and not with solvents and varnishes.

The proposed method constitutes an integrated form of producing paper, card or other flexible substrates with metallized appearance without additional conversion stages that are normally used in the production of coated substrates such as paper and card, but not exclusively limited to these substrates. The method may be used for other flexible substrates such as cloths and plastic films. The invention enables the production of versions of matt, low-sheen or high-sheen metallized substrate, the variations of sheen being associated to the choice of polymers, additional application of polymers on the already dried metallized surface and/or calendaring process. The invention thus constitutes a method for producing metallized substrates at lower production cost that the other forms set forth in group II disclosed previously.

Thus, the invention discloses a method of producing paper or a metallized flexible substrate, which comprises the application directly on a substrate, of an aqueous-base solution containing polymers having the function of ligants and metallic pigments. The polymers are chosen from among acrylic polymers, styrene/acrylic or styrene/butadiene, the metallic pigments being constituted of fine particles de metal chosen from among aluminum, bronze, zinc, silver and mixture thereof, so that the quantities of metallic pigments do not exceed 35 parts of metallic pigment per 100 parts of polymers.

In a preferred embodiment, the application of the aqueous-base solution on the substrate is by means of devices chosen from among: airknife, application blade, application roll, application bar, spray-coating system, curtain coating system.

Another preferred embodiment uses as substrate a flexible base substrate from among: uncoated paper, previously coated paper, calendared paper, card, cloth or plastic films, with varied characteristics of smoothness.

The aqueous-base solution is preferably applied on the substrate with a coating layer in a quantity of 1.0 to 15.0 g/m².

In another preferred embodiment, the application of the coating layer occurs after production of the substrate in the coating equipment outside the machine or in coating equipment integrated to the substrate-producing machines.

In yet another preferred embodiment, the method comprises a calendaring stage. Calendaring is preferably carried out after production of the substrate in the so-called supercalendars or calendars or in the calendaring equipment integrating to the substrate-producing machines.

The invention also provides a coated flexible substrate having a matt, semi-sheen or sheen metallized appearance, which comprises a flexible base substrate coated with an aqueous solution containing polymers having the function of ligants and metallic pigments. The polymers chosen from among acrylic polymers, styrene/acrylic or styrene/butadiene, the metallic pigments being constituted of fine particles of metal chosen from among aluminum, bronze, zinc, silver and mixture thereof, so that the quantities of metallic pigments do not exceed 35 parts of metallic pigment for 100 parts of polymers.

The flexible base substrate is preferably chosen from: uncoated paper, previously coated paper, calendared paper, card, cloth or plastic films, having varied characteristics of smoothness, and the aqueous base solution forms a coating layer present in a quantity of 1.0 to 15.0 g/m².

The invention also provides an aqueous-base solution that may also be called paint, which comprises polymers having the function of ligants and metallic pigments, the polymers being chosen from among acrylic polymers, styrene/acrylic or styrene/butadiene, the metallic pigments being constituted of fine particles of metal chosen from among aluminum, bronze, zinc, silver and mixture thereof, so that the quantities of metallic pigments do not exceed 35 parts of metallic pigments per 100 parts of polymers.

The aqueous-base solution preferably contains from 5 to 25% of pigments and from 95 to 75% of polymers.

The aqueous-base solution may also comprise lubricants and water retainers, in such a way that the content of solids ranges from 35 to 65%, the pH ranges from 5 to 8 and the viscosity ranges from 40 to 300 cps.

1. Method for producing metallized paper or flexible substrate, characterized by the application, directly on a substrate, of an aqueous-base solution containing polymers having the function of ligants and metallic pigments, the polymers being chosen from among acrylic, styrene/acrylic or styrene/butadiene polymers, the metallic pigments being constituted of fine particles of metal chosen from among aluminum, bronze, zinc, silver and mixture thereof, so that the quantities of metallic pigments do not exceed 35 parts of metallic pigment per 100 parts of polymers.

2. Method according to claim 1, characterized by the fact that the application of the aqueous-base solution on the substrate is by means of devices chosen from among: airknife, application blade, application roll, application bar, spray coating system, curtain coating system.

3. Method according to either of claims 1 or 2, characterized by the use as substrate of a flexible base substrate chosen from among: uncoated paper, previously coated paper, calendared paper, card, cloth or plastic films, with varied characteristics of smoothness.

4. Method according to any of claims 1 to 3, characterized by the fact that the aqueous-base solution is applied to the substrate as a coating layer in a quantity of 1.0 to 15.0 g/m².

5. Method according to any of claims 1 to 4, characterized by the fact that the application of the coating layer occurs after production of the substrate in the coating equipment outside the machine or in coating equipment integrated to the substrate-producing machines.

6. Method according to any of claims 1 to 5, characterized by also including a calendaring.

7. Method according to claim 6, characterized by the fact that the calendaring is carried out after production of the substrate in the so-called supercalendars or calendars or in calendaring equipment integrated to the substrate-producing machines.

8. Coated flexible substrate having matt, semi-sheen or sheen metallized appearance, characterized by the fact that it comprises a flexible base substrate coated with an aqueous-base solution containing polymers having the function of ligants and metallic pigments, the polymers being chosen from among acrylic polymers, styrene/acrylic or styrene/butadiene, the metallic pigments being constituted of fine particles of metal chosen from among aluminum, bronze, zinc, silver and mixture thereof, so that the quantities of metallic pigments do not exceed 35 parts of metallic pigment per 100 parts of polymers.

9. Substrate according to claim 8, characterized by the fact that the flexible base substrate is chosen from among: uncoated paper, previously coated paper, calendared paper, card, cloth or plastic films, having various smoothness characteristics.

10. Substrate according to either of claims 8 or 9, characterized by the fact that the aqueous-base solution forms a coating layer present in a quantity of from 1.0 to 15.0 g/m².

11. Aqueous-base solution, characterized by the fact that it comprises polymers having the function of ligants and metallic pigments, the polymers being chosen from among acrylic polymers, styrene/acrylic or styrene/butadiene, the metallic pigments being constituted of fine particles of metal chosen from among aluminum, bronze, zinc, silver and mixture thereof, so that the quantities of metallic pigments do not exceed 35 parts of metallic pigment per 100 parts of polymers.

12. Solution according to claim 11, characterized by the fact that it contains from 5 to 25% of pigments and from 95 to 75% of polymers.

13. Aqueous-base solution according to either of claims 11 and 12, characterized by the fact that it also comprises lubricants, water retainers and moisteners, in such a way that the solids range from 35 and 65%, the pH ranges from 5 to 8 and the viscosity ranges from 40 to 300 cps.
